(19) United States
(12) Patent Application Publication
(10) Pub. No.: US 2005/0190891 A1
(43) Pub. Date: Sep. 1, 2005

(54) Systems and methods for quality measurements of digital networks

(75) Inventors: Ankur Shah, Ocean, NJ (US); John Montalbano, Middletown, NJ (US)

Correspondence Address: Paul D. Greeley, Esq.;Ohlandt, Greeley, Ruggiero & Perle, L.L.P., One Landmark Square, 10th Floor, Stamford, CT, 06901-2682, US

(73) Assignee: IDT CORPORATION

(21) Appl. No.: 10/788,682

(22) Filed: Feb. 27, 2004

(51) Int. Cl. H04M 3/08; H04M 3/22

(52) U.S. Cl. 379/1.03

(57) ABSTRACT

A system for measuring quality of a digital network having a controller, a test dialer, a network component, and a testing function resident on the network component. The network component is remote from the test dialer and the controller. The network component communicates with the controller and the test dialer over the digital network. The controller controls the test dialer and the testing function to determine a voice quality, a call completion quality, a load capability quality, and any combinations thereof.

### BACKGROUND OF THE INVENTION

1. Field of the Invention

The present disclosure relates to digital networks. More particularly, the present disclosure relates to systems and methods for quality measurement of such networks.

2. Description of the Related Art

Digital networks are used to transmit voice using, for example, voice-over-internet protocols. The ability to periodically perform quality measurements of such voice on a digital network can be desired. For example, quality measurements allow the network operator to monitor call completion and/or to monitor voice quality. Unfortunately, prior measurement systems can not automatically perform such quality measurements down to the equipment located at the customer's premises (e.g., Customer Premise Equipment or CPE). Further, prior measurement systems can only manually and obtrusively perform such quality measurements down to the CPE. Thus, typical quality measurement systems allow the network operators to detect and isolate only a limited range of problems and/or require inconveniencing the customer.

Accordingly, there is a desire for quality measurement systems and/or methods that mitigate one or more of the aforementioned and other drawbacks and deficiencies of prior systems and methods.

### SUMMARY OF THE INVENTION

A system for measuring quality of a digital network is provided. The system has a controller, a test dialer, a network component, and a testing function resident on the network component. The network component is remote from the test dialer and the controller. The network component communicates with the controller and the test dialer over the digital network. The controller controls the test dialer and the testing function to determine a voice quality, a call completion quality, a load capability quality, and any combinations thereof.

A system for measuring quality on a digital network having a controller, a multimedia terminal adapter positioned at a point-of-service, a testing function resident on the multimedia terminal adapter, and a test dialer is also provided. The controller, adapter, and test dialer communicate over the digital network so that the testing function can receive one or more non-invasive test signals from the test dialer.

A method for measuring quality on a digital network is also provided. The method includes sending an audio signal across the digital network to point-of-service equipment having a testing function resident thereon; generating a test packet at the point-of-service equipment, the test packet being representative of the audio signal as received at the point-of-service equipment; and calculating a voice quality based at least in part on a comparison of the test packet to a reference file, the voice quality being calculated at a location other than the point-of-service equipment.

Methods for testing load capacity of a digital network are also provided. In some embodiments, the method includes controlling a plurality of points-of-service in the digital network to send a load test signal across the digital network to a central controller at a location remote from the plurality of points-of-service. In other embodiments, the method includes controlling a central controller to send a load test signal across the digital network to each of plurality of points-of-service in the digital network, the central controller being remote from each of the plurality of points-of-service.

The above-described and other features and advantages of the present disclosure will be appreciated and understood by those skilled in the art from the following detailed description, drawings, and appended claims.

### BRIEF DESCRIPTION OF THE DRAWING

FIG. 1 illustrates an exemplary embodiment of a quality measurement system and method in use with a digital network.

### DETAILED DESCRIPTION OF THE INVENTION

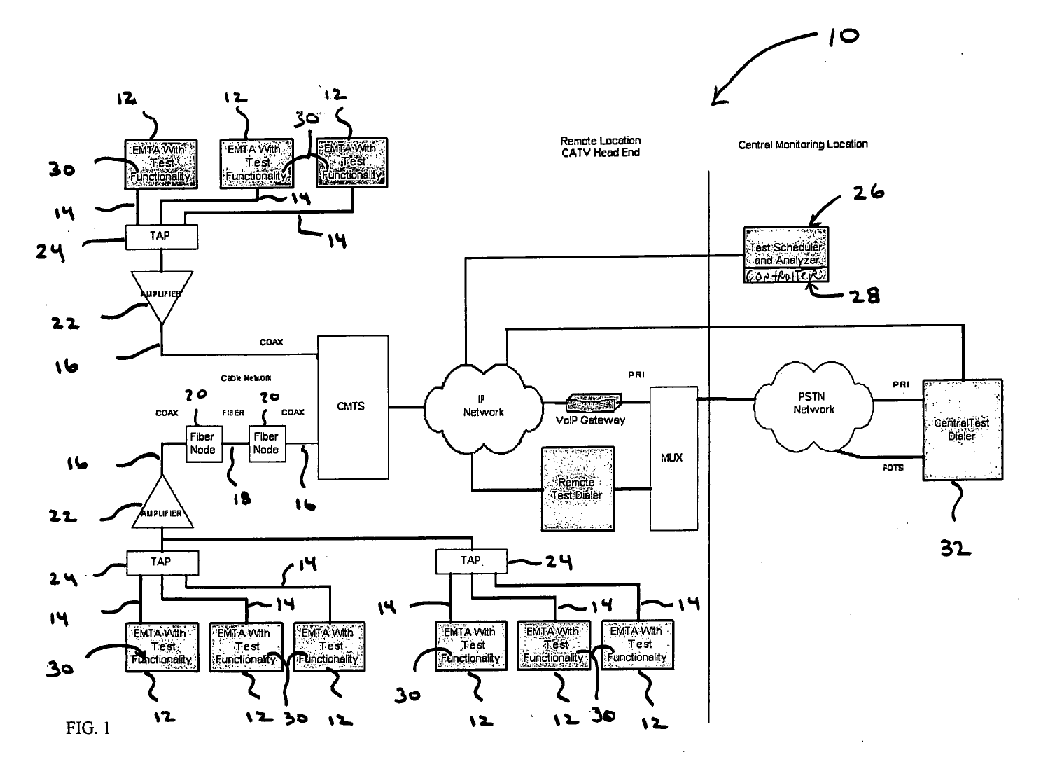

Referring now to FIG. 1, an exemplary embodiment of a digital network is generally represented by reference numeral 10. For purposes of clarity, network 10 is illustrated having a branch-and-tree topology. Of course, it is contemplated by the present disclosure for network 10 to have any topology, such as, but not limited to, star topology, ring topology, mesh topology, dual ring topology, bus topology, linear topology, fully connected topology, and any combination of one or more of the foregoing topologies.

Network 10 includes a number or plurality of multimedia terminal adapters or MTAs 12 located at a point-of-service, such as a home, a residence, an office, a wireless phone, and others. As used herein, the term multimedia terminal adapters or MTA shall mean any digital circuit, analog circuit, or combinations thereof configured to implement signal manipulation (e.g., sampling or encoding or decoding), encapsulation (e.g., encryption or framing), and/or call signaling protocols to deliver the voice-over-internet capabilities. Thus, as used herein the term MTA shall not be limited to the definition of such devices as is common in PacketCable protocols. Rather, MTA 12 using PacketCable protocols to deliver the voice-over-internet capabilities are just one example of the MTAs contemplated by the present disclosure. For example, it is contemplated by the present disclosure for network 10 to use communication protocols other than PacketCable protocols such as, but not limited to, SIP, H.323 IP, proprietary N2P, and others.

It is also contemplated by the present disclosure for MTA 12 to be an embedded MTA (eMTA) or stand-alone MTA (sMTA). Embedded MTAs 12 are integral to or embedded in a consumer electronics device, such as a telephone, a computer, an answering machine, a television, and other CPE devices. Stand-alone MTAs 12 are configured to selectively connect the consumer electronics device to network 10.

As illustrated, MTA 12 is in electrical communication with network 10 by way of one or more branch lines 14. Network 10 can also have other common network components such as coaxial cables 16, fiber optic cables 18, fiber nodes 20, and any combinations thereof. In addition, network 10 can include amplifiers 22 for amplifying signals on the network and/or taps 24 for dividing the network into the desired topology. In this manner, MTAs 12 can transmit and receive signals from network 10 in a known manner.

Unfortunately, malfunctions or errors in one or more of the components of network 10 can affect the transmission quality over the network. The result could be permanent or intermittent loss of dial-tone, dropped calls, failed calls, and/or poor audio quality. Network 10 includes a quality measurement system 26 to detect and mitigate such problems. Specifically, quality measurement system 26 is configured to measure one or more of call completion quality and voice quality. As used herein the term “quality” of network 10 as measured by system 26 includes one or more of call completion quality, a voice quality, and a load capability quality.

Advantageously, system 26 can be configured to measure quality of network 10 all the way down to each point-of-service, namely down to the CPE. In some embodiments, system 26 can measure the quality non-invasively with respect to subscriber's normal telephone calls. In still other embodiments, system 26 can calculate the quality of network 10 at a location remote from the point-of-service.

System 26 includes a central controller 28, a testing function 30, and a central dialer 32. Central controller 28 and dialer 32 are located at one or more central or provider sites. In some embodiments, central dialer 32 and central controller 28 can be integral components located at a single site. Central controller 28, testing function 30, and/or dialer 32 can be hardware, software, and any combinations thereof. For example, testing function 30 can be hardware, software, and any combinations thereof loaded on MTA 12 as illustrated in FIG. 1.

Of course, it is contemplated by the present disclosure for testing function 30 to be resident on or integrated into one or more components of network 10, such as, but not limited to, MTAs 12, fiber nodes 20, amplifiers 22, taps 24, and any combinations thereof. It has been determined that many of these network components include hardware and/or software which can be easily modified to provide testing function 30, which eliminates the need for dedicated test devices in network 10.

For purposes of clarity, system 26 is described herein by way of example having testing function 30 resident on MTAs 12 so that the system can continuously monitor network 10 to measure the quality all the way down to the point-of-service or CPE. Of course, it is contemplated by the present disclosure for testing function 30 to be resident on any component of network 10. Namely, testing function 30 can be resident on MTAs 12, fiber nodes 20, amplifiers 22, taps 24, and any combinations thereof so that system 26 can measure quality throughout network 10.

To measure call completion quality, system 26 selectively transmits a call set up signal from central dialer 32 to one or more MTAs 12. Central controller 28 can detect the receipt of the call set up signal at MTA 12 by detecting ringing of the MTA, answering by the MTA, and others. In the event that the call set up signal is not successfully received at MTA 12, central controller 28 can record the end of call reason that is available from central dialer 32.

To measure voice quality, system 26 can use known Voice Quality Testing (VQT) methods. For example, system 26 can use one or more of a Mean Opinion Score (MOS), a Perceptual Analysis/Measurement System (PAMS), a Perceptual Speech Quality Measurement (PSQM), a Perceptual Evaluation of Speech Quality (PESQ), and any combinations thereof. For example, after successfully receiving the call set up signal, system 26 can selectively transmit an audio signal from central dialer 32 to one or more MTAs 12. Testing function 30 allows MTA 12 to save the audio signal as received by MTA 12 in a sample packet and to send the sample packet to central controller 28. Central controller 28 receives the sample packet from each MTA 12 and retrieves the audio signal from the sample packet. Central controller 28 then compares the audio signal to a reference file indicative of the audio signal that was sent by dialer 32. Based on this comparison, central controller 28 calculates the desired voice quality for network 10 to the particular MTA 12.

Since the audio signal received by MTA 12 is sent to central controller 28 in the sample packet, using a reliable transfer protocol such as TCP, the audio signal represented in the sample packet is free of any additional interference or distortion that may be present in network 10 between the MTA and the central controller. In this manner, the audio signal received by MTA 12 can be sent to central controller 28 in a guaranteed fashion over the same network or a different network for comparison to the reference file.

Accordingly, system 26 measures the quality of network 10 down to each MTA 12, namely down to each home served. It has been found that measuring the voice quality of network 10 all the way down to MTAs 12 allows faulty amplifiers 22, taps 24, cables 16, 18, and/or nodes 20 to be more easily isolated than previously possible.

It has also been found that using central controller 28 to perform the computationally intensive quality calculations can offload this requirement from MTAs 12. Offloading these computationally intensive calculations from MTAs 12 can minimize the cost, size, and/or power of an MTA with the described capability. For example, it has been determined that the software resident on many current commercial-off-the-shelf MTAs can be easily upgraded to provide testing function 30. Thus, the present disclosure adds the desired testing functionality to the MTA without increasing the size or cost of the MTA.

In some embodiments, the sample packet is saved or stored in MTA 12 until the MTA is no longer in use, at which time the testing function sends the sample packet to central controller 28. It has been found that storing the sample packet for delivery when MTA 12 is not in use can also minimize the cost, size, and/or power of the MTA.

It should be recognized that system 26 by way of example having controller 28 perform both the comparison of the audio signal to the reference file and the computationally intensive calculations necessary for monitoring quality. However, it is also contemplated by the present disclosure for testing function 30 to perform some or all of the voice quality comparison and/or calculations in MTA 12.

For example, it is contemplated for central dialer 32 to transmit the reference file to MTA 12, where it is stored in memory. Here, testing function 30 can retrieve the reference file from memory and compare the received audio signal to that reference file. Again, the reference file and test packet are free of any interference or distortion that may be present in network 10 because the reference file was sent to MTA 12 using a reliable transfer protocol.

In some embodiments, testing function 30 can send a comparison packet to central controller 28 indicative of the comparison of the reference packet and the received audio signal. In other embodiments, MTA 12 can perform the calculations based on the comparison to determine the voice quality. MTA 12 can be configured to perform the calculations when the MTA is not in use. Alternately, MTA 12 can have sufficient speed and computational ability for testing function 30 to perform the calculations when the MTA is in use.

System 26 can also be configured to transmit a test audio signal from testing function 30 to central controller 28. For example, MTA 12 can receive a test packet from network 10, where the test packet includes a test audio signal. Here, testing function 30 can retrieve the test audio signal from the test packet and play that test audio signal back to a remotely located human operator or controller 28 as desired.

To measure load capability quality, system 26 can be configured to send a load test signal to test the ability of network 10 to handle various call loads. In one embodiment, system 26 is configured to control central dialer 32 to send a load test signal to each MTA 12 on network 10. In other embodiments, system 26 is configured to control each MTA 12 on network 10 to send a load test signal to controller 28. In all embodiments, the load test signals can be placed simultaneously or within a predetermined period of one another. In this manner, system 26 provides for testing the capability of network 10 to handle worst case scenario loads, such as that which could occur during an emergency condition.

Central controller 28 can control the operation of system 26 by automatically scheduling the transmission of one or more of the call set up signals, the audio signals, the test audio signals, the load test signals from central dialer 32 and/or MTAs 12 as needed. For example, controller 28 can be configured to originate test calls from central dialer 32, MTAs 12, and/or other network components on a predetermined schedule. In addition, controller 28 can be configured to originate trouble shooting test calls from the various components of network 10 in a pre-selected pattern or order. The pre-selected order can be configured to allow system 26 to automatically isolate problems down to the smallest field replaceable component without sending technicians into the field. Once system 26 determines that quality on network 10 is outside of acceptable ranges, central controller 28 can store the results, display the results, and/or forward to a desired location, such as a service repair person in the vicinity of the isolated component.

Electronic devices having embedded MTAs 12 are usually directly purchased by the consumer, these types of devices are often price-sensitive. Namely, small increases in cost of the electronics device can cause large decreases in demand for such price sensitive devices. Advantageously, system 26 mitigates impact on the price-sensitivity of these types of consumer electronics devices. Central controller 28 is not purchased by the consumer, rather by the utility operator, while MTA 12 includes minimal modification (e.g., software) to provide testing function 30. Thus, it is has been found that system 26 can be easily implemented with minimal cost increase to the customer, while providing significant monitoring advantages over what has previously been available.

It can be seen that the test calls from system 26 to/from a user's phone while useful in maintaining the operational status of network 10 could be considered intrusive and, thus, undesired by the user. Advantageously, system 26 is non-invasive to the user. Specifically, system 26 can be configured so that testing calls to MTA 12 do not cause the phone to ring and/or so that testing calls sent from the MTA do not cause the phone to be busy. In this manner, system 26 continuously monitors network 10 for failure without intrusion into the user's use and enjoyment of the network.

For example, the audio signals, test audio signals, call set up signals, and/or load test signals transmitted from central dialer 32 to MTAs 12 can include an identity character. The identity character indicates that the signal is a test signal and not a normal phone call. In some embodiments, the identity character is used by MTA 12 to prevent the incoming audio signal from ringing the phone. Here, MTA 12 does not send an output to ring the user's phone due to the incoming audio signal.

In other embodiments, MTA 12 can include a plurality of channels (not shown). Here, the identity character is used by MTA 12 to route the incoming signal to a test channel among the plurality of channels. The test channel can lack an output to a ringer. In this embodiment, the test channel can also be used to place outgoing calls from MTA 12 to central controller 28. This allows, for example, the user consumer to be speaking on the phone, while system 26 is checking signal quality to the test channel.

In this manner, system 26 can provide information from MTAs 12 in every household on network 10 so that problems, faults, and other deleterious conditions can be quickly isolated, predicted, reported, and serviced. For example, system 26 provides the ability to make non-intrusive test calls to each and every MTA 12 in network 10, thus giving the operator the ability to automatically isolate problems down to the smallest field replaceable component without sending technicians into the field. In other examples, system 26 can launch a series of calls to successive components within network 10 to narrow down possible locations of faulty equipment in the system.

It should be recognized that the embodiment of the present application are described herein by way of example for use with voice over the internet. However, it has also been found that the present disclosure finds equal use with other multimedia over the internet uses such as, but not limited to, video over the internet applications.

It should also be noted that the terms “first”, “second”, “third”, “upper”, “lower”, and the like may be used herein to modify various elements. These modifiers do not imply a spatial, sequential, or hierarchical order to the modified elements unless specifically stated.

While the present invention has been described with reference to one or more exemplary embodiments, it will be understood by those skilled in the art that various changes may be made and equivalents may be substituted for elements thereof without departing from the scope of the present invention. In addition, many modifications may be made to adapt a particular situation or material to the teachings of the disclosure without departing from the scope thereof. Therefore, it is intended that the present invention not be limited to the particular embodiment(s) disclosed as the best mode contemplated for carrying out this invention, but that the invention will include all embodiments falling within the scope of the appended claims.

1. A system for measuring quality of a digital network, comprising:
a controller;
a test dialer;
a network component remote from said test dialer and said controller, said network component being in communication with said controller and said test dialer over the digital network; and
a testing function resident on said network component, said controller controlling said test dialer and said testing function to determine at least one quality selected from the group consisting of a voice quality, a call completion quality, a load capability quality, and any combinations thereof.

2. The system as in claim 1, wherein said network component is selected from the group consisting of a multimedia terminal adapter, a fiber node, an amplifier, a tap, and any combinations thereof.

3. The system as in claim 1, wherein said network component is a multimedia terminal adapter positioned at a point-of-service.

4. The system as in claim 3, wherein said testing function is configured to determine said at least one quality without outputting an output signal at said point-of-service.

5. The system as in claim 3, wherein said multimedia terminal adapter is an embedded adapter or a stand-alone adapter.

6. The system as in claim 1, wherein said testing function is configured to receive a call set up signal from said test dialer.

7. The system as in claim 1, wherein said testing function is configured to receive an audio signal from said test dialer and send a test packet representative of said audio signal to said controller, said controller being configured to calculate said at least one quality based at least in part on a comparison of said test packet to a reference file.

8. The system as in claim 7, wherein said reference file is resident on said controller and/or on said network component.

9. The system as in claim 8, wherein said network component receives said reference file from said test dialer.

10. The system as in claim 1, wherein said testing function is configured to receive a test packet from said test dialer, convert said test packet into a test audio signal, and send said test audio signal to said controller so that said controller can calculate said at least one quality based in part on a comparison of said test audio signal to a reference file.

11. The system as in claim 1, wherein said at least one quality comprises a voice quality selected from the group consisting of a Mean Opinion Score (MOS), a Perceptual Analysis/Measurement System (PAMS), a Perceptual Speech Quality Measurement (PSQM), a Perceptual Evaluation of Speech Quality (PESQ), and any combinations thereof.

12. A system for measuring quality on a digital network, comprising:
a controller;
a multimedia terminal adapter positioned at a point-of-service;
a testing function resident on said multimedia terminal adapter; and
a test dialer, said controller, said multimedia terminal adapter, and said test dialer being in communication over the digital network so that said testing function can receive one or more non-invasive test signals from said test dialer.

13. The system as in claim 12, wherein said one or more non-invasive test signals comprises at least one signal selected from the group consisting of a call set up signal, an audio signal, a test audio signal, a load test signal, and any combinations thereof.

14. The system as in claim 12, wherein said non-invasive test signal is an audio signal, said testing function converting said audio signal into a test packet and sending said test packet to said controller.

15. The system as in claim 14, wherein said controller measures a voice quality based in part on a comparison of said test packet to a reference file.

16. The system as in claim 15, wherein said reference file is resident on said controller or on said multimedia terminal adapter.

17. The system as in claim 12, wherein said multimedia terminal adapter has a first channel for receiving said non-invasive test signal.

18. The system as in claim 17, wherein said multimedia terminal adapter has a separate channel for sending and/or receiving a normal signal while said first channel is in use.

19. The system as in claim 12, wherein said non-invasive test signal is a call set up signal.

20. The system as in claim 12, wherein said non-invasive test signal is a test audio signal, said testing function receiving a test packet having said test audio signal, retrieving said test audio signal from said test packet, and sending said test audio signal to said controller.

21. The system as in claim 20, wherein said controller measures a voice quality based in part on a comparison of said test audio signal to a reference file.

22. A method for measuring quality on a digital network, comprising:
sending an audio signal across the digital network to point-of-service equipment having a testing function resident thereon;
generating a test packet at said point-of-service equipment, said test packet being representative of said audio signal as received at said point-of-service equipment; and
calculating a voice quality based at least in part on a comparison of said test packet to a reference file, said voice quality being calculated at a location other than said point-of-service equipment.

23. The method as in claim 22, wherein said comparison is performed at either said point-of-service equipment or at said location.

24. The method as in claim 22 wherein said test audio signal is non-invasive to said point-of-service equipment.

25. A method for testing load capacity of a digital network, comprising controlling a plurality of points-of-service in the digital network to send a load test signal across the digital network to a central controller at a location remote from said plurality of points-of-service.

26. The method as in claim 25, wherein said plurality of points-of-service are controlled to send said load test signal simultaneously with one another or within a predetermined period of one another.

27. A method for testing load capacity of a digital network, comprising controlling a central controller to send a load test signal across the digital network to each of plurality of points-of-service in the digital network, said central controller being remote from each of said plurality of points-of-service.

28. The method as in claim 27, wherein said controller sends said load test signal to each of said plurality of points-of-service simultaneously with one another or within a predetermined period of one another.
